(19) United States
(12) Patent Application Publication
(10) Pub. No.: US 2014/0324214 A1
(43) Pub. Date: Oct. 30, 2014

(54) VEHICLE LIFT SYSTEM WITH SPEED EQUALIZATION AND CENTRALIZED CONTROL STATION

(71) Applicant: VEHICLE SERVICE GROUP, LLC, Madison, IN (US)

(72) Inventor: Robert W. Elliott, Madison, IN (US)

(21) Appl. No.: 14/252,909

(22) Filed: Apr. 15, 2014

Related U.S. Application Data
(60) Provisional application No. 61/817,458, filed on Apr. 30, 2013.

(51) Int. Cl. B66F 13/00; B66F 3/46

(52) U.S. Cl. CPC B66F 13/00; B66F 3/46
USPC 700/213; 254/89 R

(57) ABSTRACT

A lift control system and method including a plurality of lift columns with a lift unit having a lift mechanism configured to respond to a motion command, a lift processor configured to determine a lift speed value, and a lift transceiver configured to transmit the lift speed value. The lift control system further includes a central control unit having a central transceiver configured to receive the lift speed value from the lift control unit and a central processor configured to determine a communicated speed value in response to the lift speed value. The lift transceiver is operable to receive the communicated speed value and the lift processor is operable to modify a lift operating speed of the lift mechanism in response to the communicated speed value and the motion command.

This application claims priority to U.S. Patent Application Ser. No. 61/817,458 entitled “Vehicle Lift System with Speed Equalization and Centralized Control Station” filed on Apr. 30, 2013, the entire disclosure of such parent application being expressly incorporated herein by reference.

### BACKGROUND

Vehicle lift systems may be used to lift various kinds of vehicles relative to the ground. Some vehicle lift systems are formed by a set of mobile above-ground lift columns. An example of a mobile column lift system is the MACH 4 Mobile Column Lift System by Rotary Lift of Madison, Ind. The mobile columns may be readily positioned in relation to the vehicle. The mobile columns may then be activated to lift the vehicle from the ground on a coordinated/synchronized fashion. It may be desirable to ensure that the lift columns lift the vehicle at a substantially consistent rate, to avoid having one column raise or lower the vehicle at a speed that is significantly faster or slower than the ascent/descent speed of other lift columns. Examples of providing synchronization in a vehicle lift system are disclosed in U.S. Pat. No. 6,763,916, entitled “Method and Apparatus for Synchronizing a Vehicle Lift,” issued Jul. 20, 2004, the disclosure of which is incorporated by reference herein. It may also be desirable to provide a centralized control for a set of mobile lift columns. While a variety of systems and configurations have been made and used to control lift systems, it is believed that no one prior to the inventors has made or used the invention described herein.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 shows a perspective view of an exemplary lift system.

FIG. 2 shows a side view of an exemplary lift column of the lift system of FIG. 1.

FIG. 3 shows a perspective rear view of the lift column of FIG. 2.

FIG. 4 shows a perspective front view of the lift column of FIG. 2.

FIG. 5 shows a block schematic diagram of the lift system of FIG. 1.

FIG. 6 shows a flow diagram of an exemplary communication protocol that may be used by the lift system of FIG. 1.

FIG. 7 shows another flow diagram of an exemplary communication protocol that may be used by the lift system of FIG. 1.

FIG. 8A shows a diagrammatic view of exemplary communication of signals during an exemplary operational sequence for the lift system of FIG. 1.

FIG. 8B shows a diagrammatic view of another exemplary communication of signals during an exemplary operational sequence for the lift system of FIG. 1.

FIG. 8C shows a diagrammatic view of another exemplary communication of signals during an exemplary operational sequence for the lift system of FIG. 1.

### DETAILED DESCRIPTION

The following description of certain examples should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

### I. Mobile Column Lift System Overview

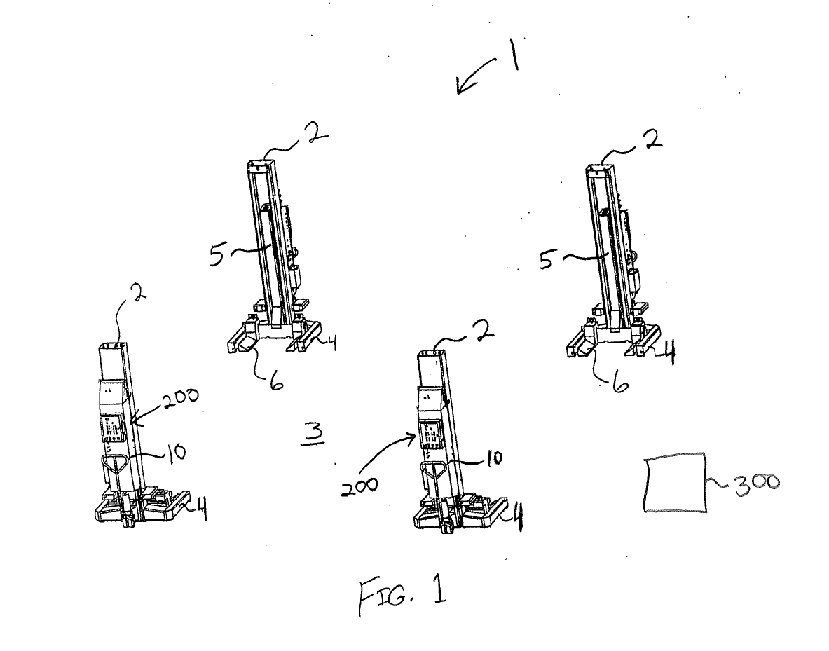

FIG. 1 illustrates an exemplary lift system (1) comprising a plurality of mobile lifting columns (2) and a centralized control module (300). Control module (300) is operable to control lifting columns (2) to selectively raise or lower a vehicle relative to the ground (3). While four columns (2) are shown, it should be understood that any other suitable number of columns (2) (e.g., six, eight, etc.) may be used to form lift system (1). Each lifting column (2) is shown to include a set of legs (4) that support lifting column (2) in relation to the ground (3). Lifting column (2) is also shown to include a support fixture or carriage (6) to provide support of the vehicle in relation to lifting column (2).

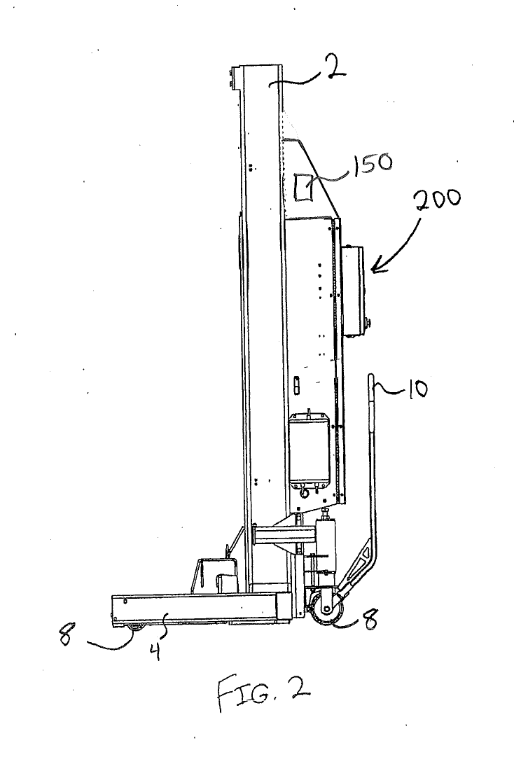

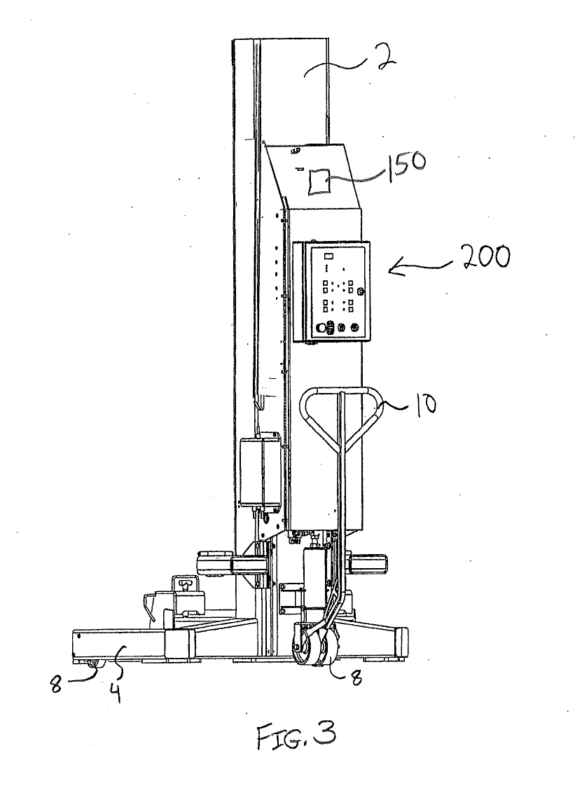

As further shown in FIGS. 2-3, columns (2) also have wheels (8) and handles (10), permitting columns (2) to be moved along ground (3). Columns (2) may thus be selectively positioned with relative ease, as may be desired to accommodate different vehicles having different wheel spacing or numbers of wheels (e.g., to move additional columns (2) into place or to move excess columns (2) away, etc.), to replace a first column (2) with a second column (2) for maintenance of the first column (2), etc.

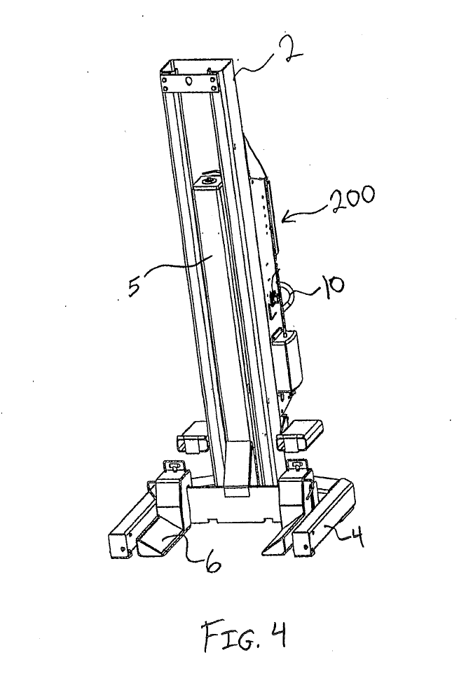

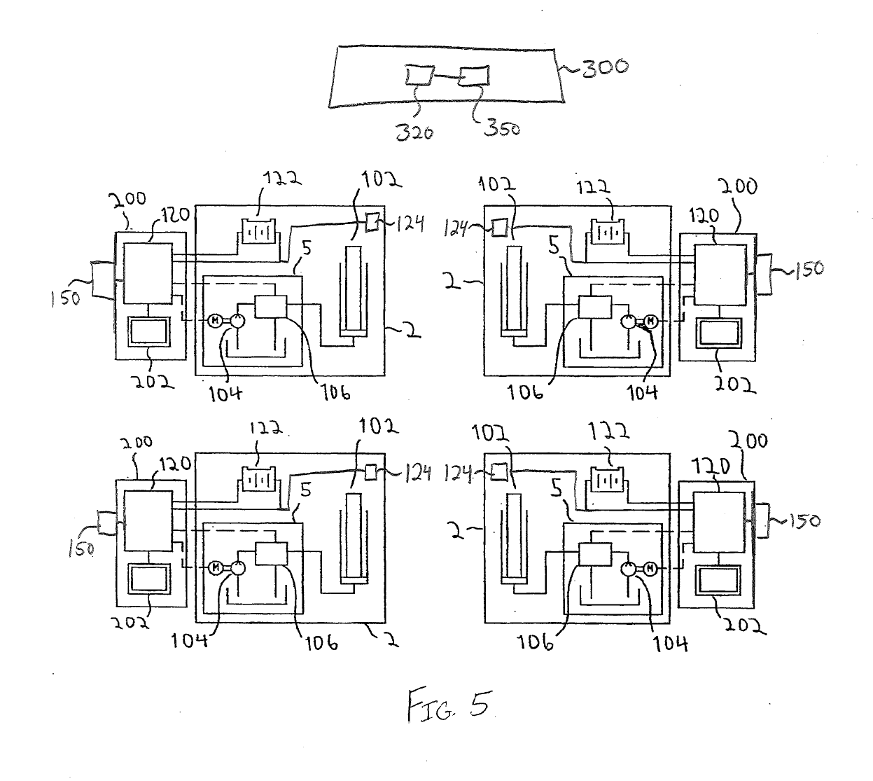

As shown in FIGS. 4-5, each column (2) further comprises a lift mechanism which is shown as a hydraulic system (5). Hydraulic system (5) is operable to move a carriage (6) vertically relative to the ground (3). Carriage (6) is configured to engage a component of the vehicle (e.g., the wheel, etc.), to thereby enable columns (2) to raise and lower the vehicle relative to the ground (3). Configuration of carriage (6) can vary to accommodate various vehicles as would be understood by one skilled in the art. As shown in further detail in FIG. 5, each hydraulic system (5) of the present example comprises a hydraulic cylinder and piston (102), a pump (104), and a series of valves (106) controlling the flow of hydraulic fluid. In particular, pump (104) and valves (106) are in fluid communication with hydraulic cylinder and piston (102), such that pump (104) and valves (106) communicate fluid to or from cylinder and piston (102). Carriage (6) ascends and descends with the piston of hydraulic cylinder and piston (102), such that pump (104) and valves (106) may be controlled to control the vertical height at which carriage (6) is positioned. A processor (120) is in electrical communication with pump (104) and valves (106) to control operation of pump (104) and valves (106). Of course, any other suitable structures, components, or techniques may be used for a hydraulic system (5). For instance, any suitable systems, features, mechanisms, or components may be used in addition to or in lieu of hydraulic system (5), including but not limited to a screw, belt or gear mechanism, such as to raise or lower carriage (6).

Each lift column (2) further includes a control interface (200), which may be used to control the operation, monitoring, and/or programming of lift system (1). For instance, any one of the control interfaces (200) may be used to define participation in ad hoc column control groups based on available columns (2); then control the columns (2) while in the ad hoc column control group. Control interface (200) also has a display (202) that is configured to provide the operator with visual indication of which columns (2) have been assigned to the ad hoc column control group. Display (202) may include a graphical representation of a vehicle and graphical representations of the available columns (2) positioned in relation to the graphical representation of the vehicle. Control interface (200) may illuminate the graphical representations of the available lift columns that have been selected for the ad hoc control group, providing the operator with immediate visual confirmation of which columns (2) have been selected and where those columns (2) are in relation to the vehicle. Control interface (200) is in communication with a processor (120), which is operable to process and relay information/commands to/from control interface (200).

By way of example, control interface (200) may be configured and operable in accordance with at least some of the teachings of U.S. Pat. No. 8,083,034, entitled “Lift Control Interface,” issued Dec. 27, 2011, the disclosure of which is incorporated by reference herein. As another merely illustrative example, control interface (200) and/or other aspects of lift system (1) may be configured and operable in accordance with at least some of the teachings of U.S. Pat. No. 6,983,196, entitled “Electronically Controlled Vehicle Lift and Vehicle Service System,” issued Jan. 3, 2006, the disclosure of which is incorporated by reference herein. It should also be understood that each control interface (200) may be in communication with control module (300). For instance, when an operator uses a control interface (200) to create an ad hoc column control group, the identity of the columns (2) in that control group may be transmitted to control module (300). In addition, a lift command entered through control interface (200) may be sent to control module (300), and control module (300) may then relay the lift command to columns (2) that have been assigned to the ad hoc column control group.

A wireless transceiver (150) is also provided at each column (2) represented in FIG. 5, and is operable to wirelessly relay information and commands between a column (2) and a centralized control module (300) as will be described in greater detail below. Various suitable forms that wireless transceiver (150) may take will be apparent to those of ordinary skill in the art in view of the teachings herein. As an alternative to wireless communication, cables or other physical connections may be used to provide hardwire communication of information and commands between column (2) and centralized control module (300).

As also shown in FIG. 5, each column (2) includes a respective battery (122). Batteries (122) are rechargeable and are operable to power all aspects of operation of their respective columns (2). In particular, each battery (122) is operable to power the pump (104), control interface (200), transceiver (150), and/or any other electrically powered component in each column (2). By way of example only, such operability may be provided in accordance with at least some of the teachings of U.S. patent application Ser. No. 14/080,240, entitled “Vehicle Lift with Locally Stored Energy Source,” filed Nov. 14, 2013, the disclosure of which is incorporated by reference herein. In addition or in the alternative, at least part of each column (2) may receive power from an external source via a wire or in some other suitable fashion.

### II. Exemplary Centralized Control

As noted above, lift system (1) of the present example comprises a centralized control module (300). By way of example only, centralized control module (300) may be housed in a structure that is separate from columns (2) but in the same facility as columns. For instance, centralized control module (300) may be located in an upright console unit (e.g., configured like a podium) mounted to the ground (3). As another merely illustrative example, centralized control module (300) may be provided in a handheld pendant or other form of handheld control. For instance, control module (300) may be incorporated into a handheld control similar to the one disclosed in U.S. patent application Ser. No. 14/202,328, entitled “Handheld Control Unit for Automotive Lift,” the disclosure of which is incorporated by reference herein. As another merely illustrative example, centralized control module (300) may be provided through a program on a conventional multipurpose computing device such as a smartphone, laptop PC, desktop PC, etc. As yet another merely illustrative example, control module (300) may be provided through a remote server or some other remote device, such that control module (300) may communicate with columns (2) via various kinds of public networks (e.g., the internet) and/or private networks (e.g., WANs, LANs, etc.). In some versions, control module (300) may be integrated into one of the columns (2). Various suitable forms that control module (300) may take will be apparent to those of ordinary skill in the art in view of the teachings herein.

As also noted above, columns (2) are operable to wirelessly communicate with control module (300) via transceivers (150). To that end, as shown in FIG. 5, control module (300) includes a wireless transceiver (350) in communication with a processor (320). Location of wireless transceiver (350) may vary and the communication type between wireless transceiver (350) and processor (320) may vary with location. It should therefore be understood that transceivers (150, 350) may be used to wirelessly communicate information and/or commands between processors (120, 320). By way of example only, transceivers (150, 350) may communicate via a conventional Wi-Fi protocol, via BLUETOOTH, via ZIGBEE, or in any other suitable fashion, protocol, or modality. While transceivers (150, 350) communicate directly in the present example, it should be understood that one or more other wireless and/or other kinds of telecommunication components may be interposed between transceivers (150, 350) to relay and/or otherwise process communications between transceivers (150, 350).

Control module (300) may be used to coordinate and synchronize operation of columns (2), such as by establishing consistent ascent/descent speeds among columns (2) as will be described in greater detail below. In the present example, processor (320) of control module (300) serves as a master control while processors (120) of columns (2) serve as slave controls. Processors (120) may provide processor (320) with information such as the status of carriages (6), the status of one or more other components within columns (2), user inputs received via interface (200), and/or other information relating to columns (2). Such information from processors (120) may be based at least in part on data from various kinds of sensors and/or other sources in columns (2) as will be apparent to those of ordinary skill in the art in view of the teachings herein.

Processor (320) processes the information from processors (120) and provides processors (120) with commands that processors (120) execute to control operation of columns (2). Processor (320) may also provide information to processors (120). For instance, processor (320) may provide processors (120) with information such as mode status, ascent/descent speed data, user display (202) information, and/or other kinds of information via transceivers (150, 350).

While each column (2) of the present example includes its own interface (200), it should be understood that control module (300) may have its own interface (200), in addition to or in lieu of each column (2) having its own interface (200).

In the present examples, processors (120) do not engage in any direct communication with each other via transceivers (150). However, in some other versions, processors (120) may communicate with each other via transceivers (150). Such inter-processor (120) communication may be provided in addition to or in lieu of communication with control module (300).

While control module (300) is shown as being part of a single lift system (1) with one set of columns (2), it should be understood that control module (300) may be incorporated into several different lift systems (1), each system (1) having its own set of columns (2). Each set of columns (2) may be operable to lift different vehicles (e.g., within the same facility or in different facilities). A single control module (300) may thus be used for control in various situations such as lifting of several vehicles simultaneously and/or lifting of different vehicles in different geographic locations, if desired.

### III. Exemplary Speed Sensing and Equalization

Lift system (1) may operate columns (2) collectively in an ascent mode and/or a descent mode. The ascent and/or descent of columns (2) may be coordinated and synchronized to ensure the stability of a vehicle on carriages (6). To that end, lift system (1) is operable to track the ascent and descent speeds of carriages (6) and adjust those speeds as necessary, on a real-time basis, to provide substantially consistent ascent/descent speeds among carriages (6). Referring to FIG. 5, each column (2) has a location sensor (124) in communication with the corresponding processor (120), which is configured to calculate travel speeds based on data from location sensor (124) and a time function. Various suitable forms that location sensor (124) may take will be apparent to those of ordinary skill in the art in view of the teachings herein. By way of example only, each location sensor (124) may be configured to sense the height of a corresponding carriage (6) relative to the ground or floor.

Each processor (120) is configured to determine the travel speed of the carriage (6) that is part of the same column (2) as processor (120). Each processor (120) in the group monitors its local location sensor (124) to track the location (e.g., height) of the corresponding carriage (6), and by extension the vehicle position (e.g., height) at that lifting point. Various points of data may be transmitted between central processor (320) and lift processor (120). The transmission of data and the capabilities of the processors (120,320) allow assignment of operations to be made to either or both processors (120,320). While discussion may include reference to one or the other processor (120,320), it is understood by one skilled in the art that either processor (120,320) could perform all or part of the various operations.

When calculating travel speeds (e.g., ascent speeds and descent speeds) for this example, each processor (120) uses its own time base to calculate the travel speed of the corresponding carriage (6) and to generate error signals based on speed values transmitted by other processors (120) to the master processor (320). The time function used to determine the travel speed has a time base which is synchronized at the beginning of a column (2) group ascent or descent movement. In some other versions, the time base may be synchronized at some time other than the beginning of carriage (6) movement. For instance, the time base may be synchronized on a set periodic basis. Master processor (320) sends out a series of synchronization broadcasts to the other processors (120) at the beginning of column (2) group movement in order to achieve a time base synchronization. Master processor (320) may also provide a time function and transmit the time function to processors (120) on lift columns (2). A broadcast message from master processor (320) may be sent out at fixed time intervals that are known by all processors (120). The synchronization message is sent as a series such that all processors (120) will establish the correct synchronization time even if only one of the messages of the series is received.

Once a time base synchronization is achieved and travel movement of carriage (6) begins, processor (120) will use the change in location information (based on data from location sensor (124)) and the change in elapsed time to calculate the travel speed of carriage (6). In other variations, the time function can be included in other processors including master processor (320). Once each processor (120) determines the travel speed of its corresponding carriage (6), each processor (120) then communicates the determined travel speed to control module (300) via transceivers (150, 350). Processor (320) then processes these travel speeds as described in greater detail below.

While processor (320) is used in the present example to process travel speeds, it should be understood that other versions may rely on the processor (120) of one column (2) to perform such processing. For instance, a first column (2) to be turned on may be automatically designated as an ad hoc master (at least until that column (2) is later turned off), such that all subsequently turned on columns (2) are designated as slaves. The processor (120) for the ad hoc master column (2) may thus serve a role similar to processor (320). It should therefore be understood that processor (320) may be eliminated as a separate component in some versions of lift system (1). Because either processor (320) or an ad hoc designated processor (120) may serve as a master in a control scheme, the following discussion will refer to both kinds of processors (120, 320) collectively as a master processor (120, 320).

When synchronized movement of carriages (6) begins, the master processor (120, 320) will poll each column (2) in the lifting group in series, and each processor (120) will respond with its speed value. The master processor (120, 320) will pick a target speed such as the slowest speed, for example, which will be transmitted out to all processors (120) as a broadcast message. When processors (120) receive a target speed from a broadcast message, they will evaluate it with respect to their local carriage (6) travel speed to calculate an error signal to be input to an equalization algorithm. Processors (120) then make adjustments using pump (104) and/or valves (106) to correct for speed discrepancies. For instance, since the slowest speed is established as the target speed in the present example, processors (120) of the non-slowest columns (2) may adjust the state of the respective valves (106) to slow down the respective carriage (6) in ascent or descent.

In some other versions, the master processor (120, 320) compares the ascent/descent speeds and identifies any columns (2) having a carriage (6) with an ascent/descent speed deviating from the ascent/descent speeds of the other carriages (6). If a column (2) is identified as having an ascent/descent speed that deviates from the ascent/descent speeds of the other carriages (6), master processor (320) sends a command to processor (120) for that particular column (2) to adjust the ascent/descent speed using pump (104) and/or valves (106).

Regardless of whether speeds are compared by processor (320) or processors (120), the speed data may be continuously monitored and deviant speeds may be adjusted to maintain consistency in the ascent/descent speeds of all carriages (6) in lift system (1) during the full range of ascent and descent. Various suitable ways in which pumps (104) and/or valves (106) may be manipulated to adjust ascent/descent speeds will be apparent to those of ordinary skill in the art in view of the teachings herein. In some versions, processor (120, 320) is configured to tolerate a certain nominal degree of deviation among ascent/descent speeds. Suitable values for tolerable speed deviations will be apparent to those of ordinary skill in the art in view of the teachings herein.

When a stop movement event is generated, the master processor (120, 320) will send a series of broadcast messages to stop movement and record a final speed target. Since carriage (6) movement may continue after a stop event is generated, due to inertia, missed messages, and/or other factors, the final speed target is recorded after a certain period of time (e.g., 2 seconds) has elapsed after the stop event. The final speed target will be transmitted to the processors (120), but will not be sent to the equalization algorithm since carriage (6) movement will have already stopped. Instead, the speed difference will be stored at each column (2) and added to the error signal during the next carriage (6) movement. Any other unintended movement that may occur outside of controlled movements (e.g., from leaking hydraulics, etc.) will also be stored at the column (2) and accounted for during any subsequent carriage (6) movements to maintain level lifting within the lift group.

In the present example, the target speed is based on the ascent/descent speed of the slowest carriage (6), such that faster carriages (6) are slowed down to reach an ascent/descent speed consistent with that of the slowest carriage (6). In other versions, the target speed may be based on the ascent/descent speed of the fastest carriage (6), such that slower carriages (6) are sped up to reach an ascent/descent speed consistent with that of the fastest carriage (6). Alternatively, the target speed may be based on a predetermined profile. For instance, such a predetermined profile may be a function of speed-determining factors such as lift load, battery charge status, etc.

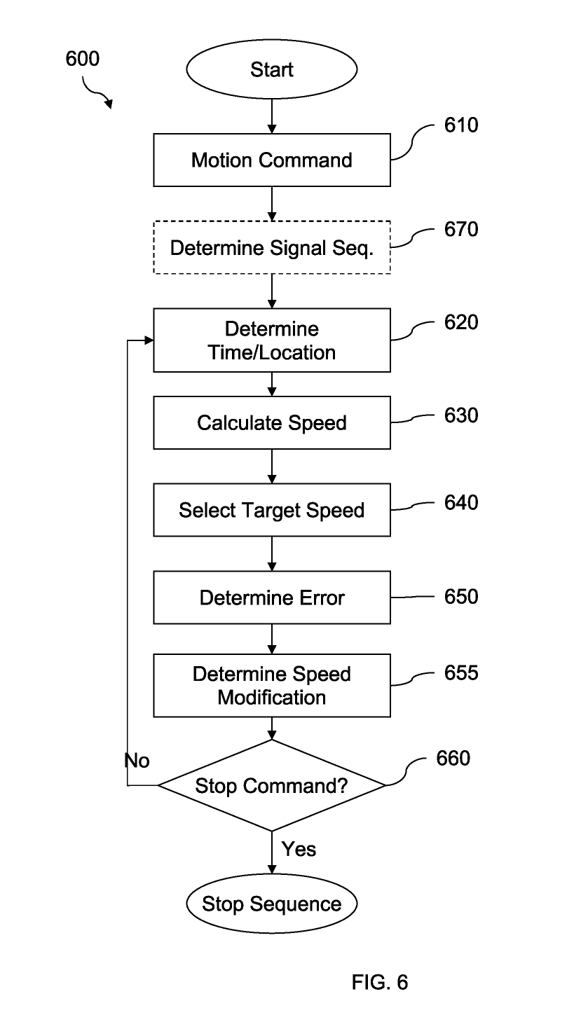

FIG. 6 illustrates an exemplary motion process (600) for controlling and operating a set of lift columns (2). Motion process (600) starts with a command in motion command procedure (610), where the command is sent from a master control module (300) to the lift control units (120) of the lift columns (2). A motion command may be initiated by manual or automatic methods. In some versions, an operator enters a command via a control interface (200) on any of the lift columns (2). The command is then sent to the master control module (300). In some other versions, an operator enters a command directly in the master control module (300). Automatic commands may be part of a preprogrammed sequence for procedures such as but not limited to system stabilization, system reset after a set period of time, or system shutdown. In a motion command procedure (610), the command is then received by the set of lift columns (2) with lift mechanisms (5) being capable of manipulating the lift column (2) to various positions. For instance, master control module (300) may push the command out to the lift control units (120) of the lift columns (2). The motion in motion command procedure (610) may be an ascent or a descent of carriages (6).

Also in response to the motion command, a timing procedure (620) sets a time base for the lift columns (2) to start timing, thereby synchronizing the lift columns (2). As the carriage (6) of each lift column (2) moves and the timing continues, timing procedure (620) collects location data from sensors (124) for all active lift columns (2). Any suitable conventional kinds of sensors may be used for sensors (124) in this example. A speed calculation procedure (630) calculates a lift speed based on the timing and location information from timing procedure (620). The lift speed for each lift column (2) is transmitted to the control module (300). Once the control module (300) collects the lift speeds, a selection procedure (640) considers the lift speeds and selects a target lift speed. The target lift speed is transmitted to the lift columns (2). In an error calculation procedure (650), each column (2) is capable of applying a synchronization algorithm as a function of the target lift speed from the control module (300) and the calculated lift speed for the subject lift column (2). The synchronization algorithm determines a lift speed error value in error calculation procedure (650). The lift speed error value is applied in a modification procedure (655), where the lift speed is modified in response to the lift speed error value. A conditional step (660) considers whether a stop command has been received. If there is no stop command, then timing procedure (620) through conditional step (660) may be repeated as the lift system (1) is operated to maintain synchronization of the ascent speed or descent speed among columns (2).

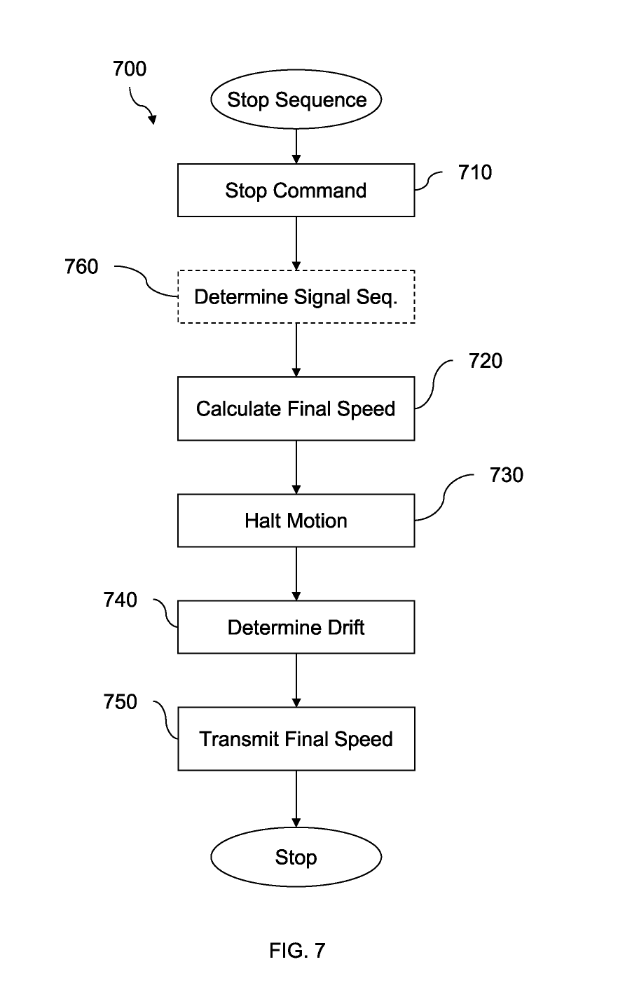

When conditional step (660) indicates that a stop command has been received, the lift column (2) stops motion in a stop process (700). FIG. 7 illustrates an example of a stop process (700). Stop process (700) starts with a stop motion command being received in a command procedure (710). Next, a calculating procedure (720) calculates a final speed when the stop motion command is received. In another variation, the final speed may be calculated following a set period of time after the stop motion command is received. A halt procedure (730) communicates a halt command to stop the lift column (2). A drift procedure (740) determines the degree of drifting for the lift columns (2) during halt procedure (730). Drift procedure (740) evaluates the accuracy in which the lift column (2) halts its motion. Load level and speed values are factors that may be used in drift procedure (740). Transmit procedure (750) transmits a final travel speed to the control module (300), which may account for residue travel in the lift column (2). In a further example, the final travel speed may be stored for application in motion process (600) when a motion command is subsequently received. The final travel speed may be applied to account for variable stopping distances amongst carriages (6) of lift columns (2).

In some instances, control module (300) may repeat transmission of a motion command. Repeated transmissions may be sent to increase the opportunity for lift columns (2) to receive a motion command. Certain environments having elements such as but not limited to physical obstructions and signal interference may limit the reliability of command reception. A part of motion command procedure (610) can include a transmission procedure (670) that receives the motion command transmissions, each being tagged with a sequence number, so the lift column processor (120) is able to determine the time base of the motion command as a function of a known interval between motion command transmissions and the sequence number of the motion command transmission received. The lift column (2) is able to set the proper time base if at least one of the motion command transmissions is received when transmission of the motion commands may encounter interference.

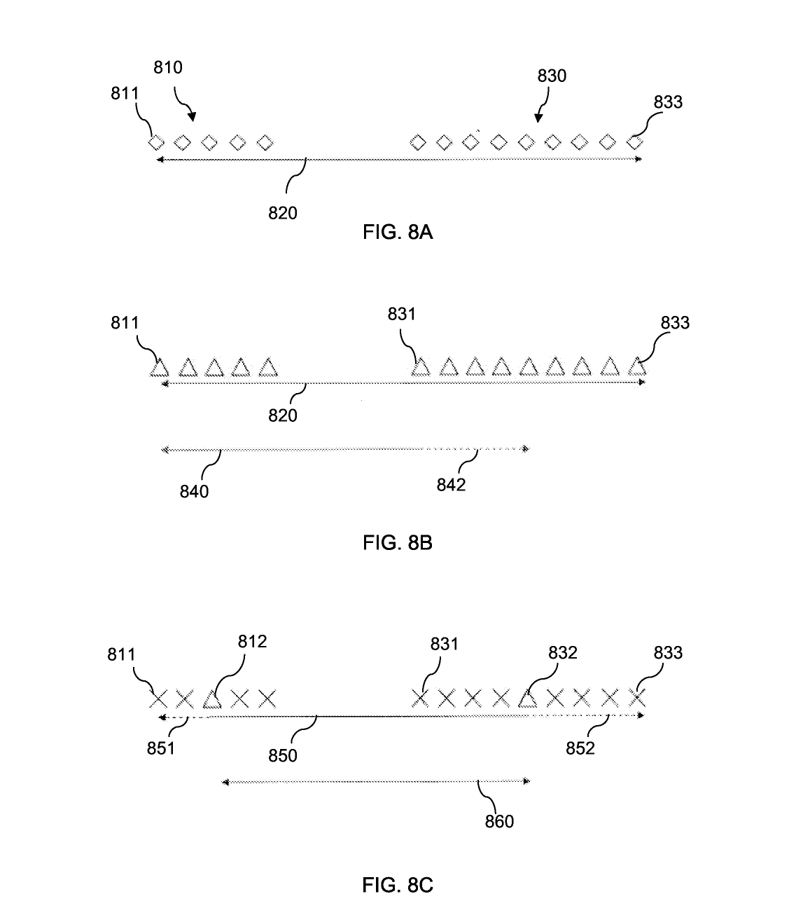

A depiction of transmission signals for various operations of motion process (600) and stop process (700) are illustrated in FIGS. 8A-8C. In FIG. 8A, a control module (300) sends a series of messages (810) in motion command procedure (610) to synchronize a time base at the beginning and end of a lift movement. Each diamond shown as part of a series of messages (810) represents a transmission of the motion command. Messages (810) are sent at a fixed rate such as 250 ms, for example, and each message is numbered. Thereby, a lift control unit (120) may synchronize a proper time base (820) even if only one message is received. The time base (820) of FIG. 8A is shown to begin with the first transmitted message (811).

Stop command signals of stop process (700) are transmitted for stopping the motion of lift columns (2). In this illustration, a series of motion stop commands (830) may also include a fixed frequency and number sequence. When, as in the case of FIG. 8A, the first stop transmission (831) is received in command procedure (710), the lift control unit (120) operates under stop process (700) to halt motion and record final speeds. The time base (820) extends from the first motion command message (811) of the series of messages (810) to the final stop command (833) of the series of messages (830).

The illustration of FIG. 8B illustrates the time base (820) of a lift motion command that extends from the first transmitted motion command (811) to the last transmitted stop command (833). A corresponding motion line (840) begins with the first received motion command massage (811) and ends with the first received stop command message (831). Further, motion line (840) depicts drift characteristics of the lift columns (2) in a drift section (842) of motion line (840), following the halting point of the first received stop command message (831). Drift characteristics describe at least in part the continued drift of a carriage (6) after a motion stop command due to inertia. Stop process (700) considers the drift characteristics and the time and speed when a stop command is received in drift procedure (740) to aid in determining position and target speed at restart or the next movement cycle. This method may prevent equalization problems arising from successive short movement cycles.

The illustration of FIG. 8C includes a lift system (1) operating in what may be considered an electrically noisy environment where messages from a central control module (300) may not be received. During the start of motion process (600) for a lift movement, the lift control unit (120) receives only the third synchronization motion command message (812). But because the messages are enumerated and occur at regular intervals, the lift control unit (120) can calculate the original message synchronization point (811). The time base (850) includes an extended portion (851) from the first received motion command message (812) to the beginning of the motion command transmission (811). With the extension, each lift column (2) is able to establish a synchronized time base (850) with an equivalent start.

Likewise, during stop process (700), the lift control unit (120) can determine from just one of the stop broadcasts (832) when to halt the carriage (6) and record the final speed target. Time base (850) includes an extended portion (852) from the received stop command message (832) to the final broadcast stop command (833) based on the sequence number of the received message and a pre-set interval. Consideration may be made to accommodate the altered start and stop of the lift column (2). The altered timing due to a missed command may provide a variable motion line (860). With a synchronized time base, each column (2) is able to operate a synchronized time function when determining travel speeds, which are then transmitted to the control module (300) and evaluated for target travel speeds of the lift system (1).

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

What is claimed:

1. A lift control system including a plurality of lift columns, the lift control system comprising:
(a) a lift control unit for each of the plurality of lift columns configured to determine a lift speed value; and
(b) a master control unit configured to determine a communicated speed value in response to the lift speed value;
wherein the lift control unit is operable to modify an operating speed in response to the communicated speed value.

2. The lift control system of claim 1, wherein the lift control unit further includes a lift transceiver configured to transmit the lift speed value and receive the communicated speed value.

3. The lift control system of claim 1, wherein the master control unit further includes a master transceiver configured to receive the lift speed value from the lift control unit.

4. The lift control system of claim 1, wherein each of the plurality of lift columns further includes at least one of a set of legs, a wheel, a handle, a support fixture, and a battery.

5. The lift control system of claim 1, wherein each of the plurality of lift columns further includes a lift mechanism.

6. The lift control system of claim 1, wherein the lift control unit further includes a lift processor configured to calculate a speed error in response to the lift speed value and the communicated speed value and wherein the lift control unit is operable to modify the operating speed in response to the communicated speed value and the speed error.

7. The lift control system of claim 1, wherein a first lift unit of one of the plurality of lift columns operates as the master control unit.

8. A lift control system including a plurality of lift columns, the lift control system comprising:
(a) a lift unit for each of the plurality of lift columns, the lift unit having
(i) a lift mechanism configured to respond to a motion command,
(ii) a lift processor configured to determine a lift speed value or a lift height value, and
(iii) a lift transceiver configured to transmit the lift speed value or lift height value; and
(b) a central control unit having
(i) a central transceiver configured to receive the lift speed value or lift height value from the lift control unit, and
(ii) a central processor configured to determine a communicated speed value in response to the lift speed value or lift height value,
wherein the lift transceiver is operable to receive the communicated speed value and the lift processor is operable to modify a lift operating speed of the lift mechanism in response to the communicated speed value and the motion command.

9. The lift control system of claim 8, wherein the central transceiver is further configured to transmit a motion command and the lift transceiver is further configured to receive the motion command.

10. The lift control system of claim 8, wherein the lift processor is further configured to calculate a speed error in response to the lift speed value or lift height value and the communicated speed value and to modify the lift operating speed of the lift mechanism in response to the speed error and the motion command.

11. The lift control system of claim 8, further including a location sensor capable of determining a location value of the lift unit.

12. The lift control system of claim 11, wherein the lift unit further includes a timing module.

13. The lift control system of claim 8, wherein the central control unit further includes a timing module.

14. The lift control system of claim 8, wherein a first lift unit of one of the plurality of lift columns is configured to operate as the master control unit.

15. A method for controlling a lift system comprising:
(a) performing a lift movement with a plurality of lift units in response to a motion command;
(b) starting a time value in response to the motion command;
(c) calculating a lift speed value in response to the time value and a lift location value for each of the plurality of lift units;
(d) selecting a communicated speed value in response to the lift speed values for each of the plurality of lift units;
(e) determining a speed error in response to the communicated speed value and the lift speed value for each of the plurality of lift units; and
(f) modifying a lift speed profile in response to the speed error for each of the plurality of lift units.

16. The method of claim 15, wherein said starting the time value further includes determining a signal sequence number from the motion command and starting the time value in response to a time interval, the signal sequence number and the motion command.

17. The method of claim 15, further including responding to a stop command.

18. The method of claim 17, wherein said calculating the lift speed value further includes determining a stopping distance error in response to a final location value during the stop command and determining the lift location value in response to a lift location sensor signal and the stopping distance error.

19. The method of claim 15, further including returning to said performing the lift movement following said modifying the lift speed profile.
